(19) United States
(12) Patent Application Publication
(10) Pub. No.: US 2002/0032642 A1
(43) Pub. Date: Mar. 14, 2002

(54) Internet based secure virtual exchange and distributed relational database for cross border trading of securities

(76) Inventor: Graciela Chichilnisky, New York, NY (US)

Correspondence Address: WILSON SONSINI GOODRICH & ROSATI, 650 PAGE MILL ROAD, PALO ALTO, CA, 943041050

(21) Appl. No.: 09/915,230

(22) Filed: Jul. 24, 2001

Related U.S. Application Data
(63) Continuation-in-part of application No. 09/687,651, filed on Oct. 13, 2000.
(60) Provisional application No. 60/159,237, filed on Oct. 13, 1999.

(51) Int. Cl. G06F 17/60

(52) U.S. Cl. 705/37

(57) ABSTRACT

A method and system provides an Internet based secure virtual exchange and distributed relational database for cross border security transactions. The method and system reduce the number of times a cross border security transaction is ‘touched’, reduce the number of failed cross border security transactions, reduce the fees paid by global custodians for cross border security transactions, provide a generic network of subcustodians organized around an Internet based secure virtual exchange with a distributed relational database, provide online matching, clearing, execution and settlement of online trades, provide global trading support platforms and information sources to support cross border security transactions, coordinating and recording all SWIFT messages associated with a single cross border trade. The distributed relational database can be utilized for execution, trade settlements, and corporate action events processing and is accessed through common browsers by asset managers, broker dealers, global custodians, and subcustodians.

### RELATIONSHIP TO COPENDING APPLICATION

This application is a continuation-in-part of U.S. application Ser. No. 09/687,651 filed Oct. 13, 2000; which claims priority to Provisional Application No. 60/159,237 filed Oct. 13, 1999, all of which are incorporated herein by reference.

### BACKGROUND

1. Field of the Invention

This invention relates generally to cross border trading of securities, and more particularly to an international Internet based secure virtual exchange and distributed relational database for cross border trading.

2. Description of the Related Art

International securities trading is now at a record volume, with about 1,200,000 equity trades daily amounting to $30 trillion per year. This trend is accelerating and trading is expected to double in 3-5 years, according to the President of the New York Stock Exchange. This explosive growth of cross border trading leads to widespread profits and gains, but at the same time it strains current facilities, which were created for much lower volumes, exposing their inadequacy. About 20% of cross border trades currently fail, with the attendant costs, loss of control and value at risk. In executing cross border trades, banks, broker dealers and asset managers, currently spend an estimated $86 billion. Custodian banks alone spend tens of dollars in each cross border trade, using slow and antiquated systems that involve an awkward combination of telex, fax, telephone and electronic means.

A key problem in extending today's e-trading to global markets is the lack of processing facilities at the global level, which makes it impossible to duplicate the US solutions offered by E*Trade, DATEK, or Ameritrade. There is no global equivalent to the US Depository Trust Clearing Corporation (hereafter the DTCC), which holds in its electronic vaults the records of assets for US traders and greatly facilitates clearing and settlements of electronic transactions. The DTCC itself has not and cannot be extended to other countries due to sovereign regulations and restrictions in the holding of national assets such as securities.

As previously mentioned, global cross border trading amount to $30 trillion per year and is expected to double in the next three to five years. Despite the scope of this investment, there are no end-to-end facilities to track the status of these trades, as they move from trade instructions and matching, through payments, settlement and ownership transfer. Directly, or more generally indirectly through their broker dealers, investors rely on a combination of telephone, fax, telex, and electronic means to track the execution and settlement of their cross border trades.

Since the equivalent to the DTCC does not exist globally, equity itself is kept at the vaults of different banks in their native locations around the world, even as its ownership changes. These are the ‘subcustodian banks’, which are linked together by ‘global custodian banks’. Through their network of subcustodians, these global custodians provide the investor with a central point for transfer of ownership and record keeping, and provide a host of corporate services, such as tracking dividends and other corporate actions and facilitating the borrowing and lending of securities. These services are costly and somewhat awkward at present. The entire process does not provide asset managers and broker dealers with the online information and control of their portfolios that is so important in today's rapidly changing markets. Most securities transactions are handled by dated methods: payments and delivery are often done manually, and typically occur several hours apart, leading to operations risks.

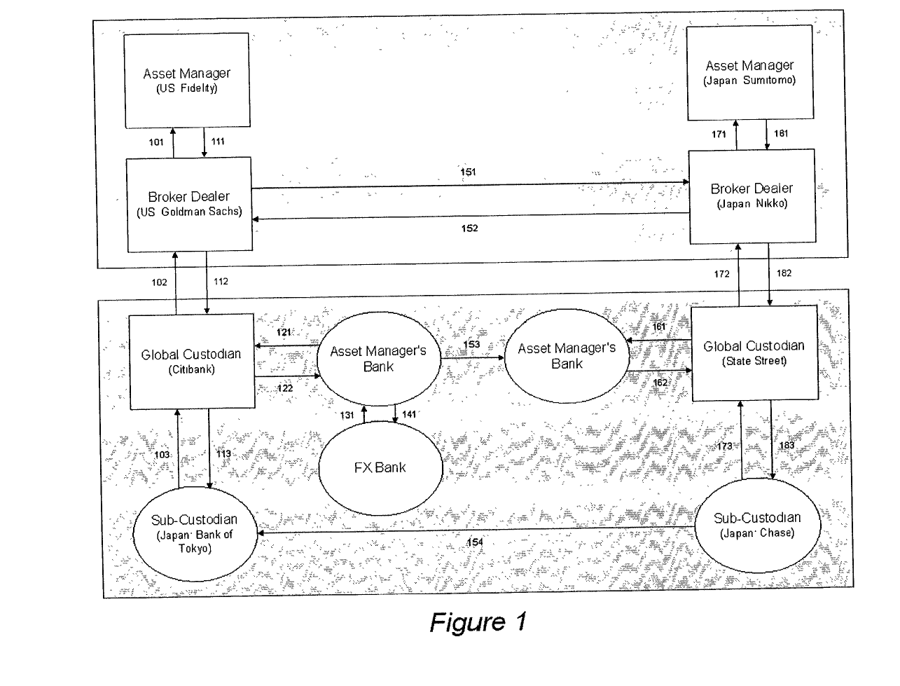

FIG. 1 illustrates trade processing today. The asset manager gives instructions to its broker dealer; they match, confirm, and affirm the details of trades (steps 101, 111, 151, 152, 171, and 181). The broker dealer attaches customer specific information to the trade data (e.g. global custodian identity, method and timing of payment, currency), and forwards the information to the global custodian in the form of an execution file (steps 112 and 182). The global custodian attaches its own “standing instructions” and communicates with the appropriate subcustodians in the countries where the securities are held, sending information about expected date of payment and currency (e.g. steps 113 and 183), and eventually obtaining from them information about the completion of the trade execution and settlement (steps 103 and 173). The asset manager or the broker dealer do not receive information from its source, the subcustodian, but rather as it is rekeyed, reorganized, and forwarded to them from the global custodian (steps 101, 102, 171, and 172).

The global custodian has to reconcile its data continuously with each of the subcustodians during this process, and must continuously adapt and reformat the data to offer the client (asset manager or broker dealer) integrated reports on its entire portfolio, containing information that is distributed across several subcustodians. If the trade fails, the process is several times more complex, because there is no automatic way to trace the source of the problem. A failed trade can cost hundreds or thousands of dollars in time, communications, as well as in the borrowing of securities when necessary.

On average a cross border transaction is “touched” 21 times by different institutions in different countries before it settles. Each country has different clearing and settlement rules and also different timings. As a result, about 20% of such trades fail, meaning that they do not settle as, or when, agreed. Often broker dealers must make good on these trades, leading to the costly borrowing of securities in order to make up for the failure. Preliminary research indicates that the costs involved in the entire post-trade process can amount to 3-4% of the value of cross border securities traded. This figure is orders of magnitude higher than the cost of clearing and settlement of domestic US trades, which is a few cents.

Exposure risks arising from lack of timely information and action can be even costlier in today's rapidly fluctuating global markets. To avoid such costs, asset managers often rely on their ‘prime brokers’ to absorb these risks; for example, hedge funds rely on Goldman Sachs and Morgan Stanley for this purpose. In reality, the costs are transferred to the asset manager in one way or another. In any case, the asset manager always faces the risks of failure by its broker dealers, which could lead to major widespread losses for the asset manager itself.

A global custodian bank holds assets on behalf of investors and broker dealers. Networks of foreign banks that are organized by global custodians play a central role in processing cross border trading, and in managing investor's portfolios. The importance of these networks arises from the lack of a global stock exchange and of a global equivalent for the DTCC, which keeps an electronic record of ownership transfers in the US. Securities are an important part of a country's assets and liabilities and, by custom or regulation, they are physically held in the respective countries. The banks that hold them are the subcustodians. For example, Italian securities are held at a subcustodian bank in Italy, and Japanese equity at a subcustodian bank in Japan. These banks have to meet local regulatory requirements and, if they are to hold the securities of US fiduciary institutions, must meet capital adequacy requirements set by the US SEC.

The role of the global custodian is to organize the network of subcustodians offering a one-stop shop for the investor and the broker dealer, providing a unified format for information on transfer of ownership and a range of portfolio related services to the institutional investors who are their clients. A list of the main global custodians in the US and their market shares is provided below. The total value custodized in the US is approximately $40 trillion yearly, as shown in Table 1 below, of which about 30-40% are cross border securities. These figures represent the assets held; through trading these assets have a 75% turnover yearly.

TABLE 1

| 2000 | Global Custodian | Assets in $ billions |
|---|---|---|
| 1 | Bank of New York | 6,700 |
| 2 | State Street | 6,200 |
| 3 | Chase Manhattan | 5,700 |
| 4 | Citibank N.A. | 3,900 |
| 5 | Deutsche Bank | 3,900 |
| 6 | ABN Amro Mellon | 2,700 |
| 7 | Northern Trust | 1,600 |
| 8 | HSBC Bank plc, | 1,141 |
| | Global Investor Services | |
| 9 | Bank Paribas | 953 |
| 10 | Brown Brothers Harriman | 890 |
| 11 | Royal Trust/Royal Bank of Canada | 710 |
| 12 | Societe Generale | 653 |
| 13 | Credit Agricole Group | 523 |
| 14 | Fortis Bank | 376 |
| 15 | Commerzbank AZ | 337 |
| 16 | Banca Commerciale Italiana | 327 |
| 17 | Investors Bank and Trust Company | 297 |
| 18 | Skandinaviska Enskilda Banken | 240 |
| 19 | HSBC, Custody and Clearing | 225 |
| 20 | Kas-Associate N.V. | 210 |

The fees associated with global custody can be an important part of a bank's revenues: in the case of Chase, which has about 20% of the global custodial market, it is reported that custody related services amount to a significant part of its revenues. Chase reportedly spends about $1.2 billion yearly in its global custody operations. It custodizes about $5.7 trillion in assets, of which 30-40% are cross border. Chase is the global leader in cross border custody. It is estimated that global custodians spend about $26 on each trade, although this number can be higher by an order of magnitude in the case of exceptions. Yet global custody fees are rather small, around 10 basis points (0.01%) of the value held yearly, and represent a ‘loss leader’ for other associated services, such as the borrowing and lending of securities that are linked to custodial operations.

The pricing strategy is complex. Global fees for lending securities vary, on average representing 15-20 basis points. In so-called ‘specials’, such fees can be 200-300 basis points (2-3%) of the value borrowed or even higher. Borrowing is naturally associated with cross border trading. When a trade fails, the traders borrow to make good on the failed transaction and this borrowing can cost an order of magnitude more than the custodial fees.

Borrowing is a major revenue source for the global custodians. With about 20% of all cross border trades failing, and with a 75% turnover of the $40 trillion currently under custody, of which 30% are cross border, the cross border operations require borrowing of securities, for which the fee can exceed $5 to 10 billion yearly. This is only one part of the costs involved in cross border trading, which include, in addition, the costs incurred by the broker dealers that initiate and clear the trades, as well as the costs incurred by the asset managers themselves.

There are, in addition, ‘value at risk’ costs, which are associated with market risks, and which have been quantified at about $52 billion for cross border trades globally. In a volatile market, these costs could be the most expensive of all, underscoring the increasing need for services and products that provide online risk evaluation and portfolio management in today's accelerating trading cycles.

A global custodian receives the details of the trade execution (in the format of an execution file requiring at least steps 101, 111, 171, 181, 151, 152, 112, and 182 in FIG. 1) and settlement from their subcustodian banks (requiring at least steps 103, 154, and 173, FIG. 1) and passes on this information to the asset managers and broker dealers in a standardized format (steps 101, 102, 171, 172, FIG. 1), attempting to meet their requirements. A major global custodian has a large network of subcustodians around the world that are unrelated to the global custodian itself. A partial list of the major subcustodians is given below:

| | |
|---|---|
| Australia | ANZ Custodial Services |
| | Citibank |
| | Commonwealth Custodial Services |
| | HSBC, Custody and Clearing |
| Brazil | ABN AMRO Bank N.V. |
| | BSCH Securities Services |
| | BankBoston NA. |
| | Citibank |
| | Deutsche Bank |
| Hong Kong | ABN Amro Bank N.V. |
| | Citibank |
| | Deutsche Bank |
| | Development Bank of Singapore |
| | HSBC, Custody and Clearing |
| Japan | Citibank |
| | HSBC, Custody and Clearing |
| | Sumitomo Bank |
| Germany | BNP Paribas |
| | Citibank |
| | Commerbank AG |
| | Deutsche Bank |
| | Dresdner Bank AG |
| United Kingdom | ABN Amro Bank N.V. |
| | BNP Paribas |
| | Bank One. NA |
| | Citibank |
| | Deutsche Bank |

There are very few subcustodians in each country, on average about 5. See the chart below:

1999

| | Number at | Market share of |
|---|---|---|
| | subcustodians | leader (%) |
| United States | 11.0 | 33.3 |
| United Kingdom | 9.0 | 38.9 |
| Spain | 8.0 | 27.8 |
| France | 8.0 | 50.0 |
| Australia | 7.0 | 38.9 |
| Hong Kong | 6.0 | 50.0 |
| Italy | 6.0 | 38.9 |
| Japan | 6.0 | 55.6 |
| Singapore | 6.0 | 27.8 |
| Switzerland | 6.0 | 50.0 |
| Austria | 5.0 | 72.2 |
| Canada | 5.0 | 66.7 |
| Germany | 5.0 | 55.7 |
| Netherlands | 5.0 | 38.9 |
| New Zealand | 5.0 | 38.9 |
| Belgium | 3.0 | 44.4 |
| Finland | 3.0 | 88.9 |
| Norway | 3.0 | 55.6 |
| Sweden | 3.0 | 72.2 |
| Denmark | 2.0 | 83.3 |
| Average | 5.6 | 51.1 |

In addition to their role in settlements, the subcustodians also keep track of post trade portfolio events such as corporate actions (dividends, splits, tenders, and rights issues), as well as taxes and other local obligations which are country specific, and which are essential to manage a portfolio. In addition, the global custodian lends the stocks held by the subcustodian on behalf of their clients, the institutional investors or broker dealers, creating another source of data exchange.

The main communication between the global custodians and their subcustodians is through the industry run network called SWIFT. Traditionally available only to banks, SWIFT has been extended to investment banks but does not offer the range of services increasingly required by the institutional investor, which the global custodian must provide on its own for its subcustodians and clients. Their services today are reliable and good after a fashion, but their X.25 proprietary network technology dates to the 1970's and their services are limited and fall short of what the market requires to minimize costs and control portfolio risks. More and more clients want to see their portfolio data integrated, but SWIFT does not provide the facilities to do so, since it is a point-to-point message service and does not provide a distributed relational database. There is little flexibility in the messages themselves; for example, SWIFT has no way to identify the various messages (e.g., payments and settlement instructions) that are associated with a single trade. There are few facilities to trace and solve the sources of failed trades. SWIFT has two messages to communicate satisfactory settlement, 531 and 533, and one that is a notification of a discrepancy (MT534). In order to trace the source of the failure, SWIFT provides 20 ISO approved reasons (e.g. short stock, no payment by counterparty), while major global custodians, such as the Bank of New York, need about 70 such reasons to meet their internal specifications.

In summary, to improve and enhance the existing system, taking advantage of modem technologies, there is a need for a system that implements the following:

An Internet based secure virtual exchange and distributed relational database for cross border security transactions.

A reduction in the number of times a cross border security transaction is ‘touched’.

A reduction in the number of failed cross border security transactions.

A reduction in the fees paid by global custodians for cross border security transactions.

A generic network of subcustodians organized around an Internet based secure virtual exchange with a distributed relational database.

Online matching, clearing, execution and settlement of online trades.

Global trading support platforms and information sources to support cross border security transactions.

Coordinating and recording all SWIFT messages associated with a single cross border trade.

Creating a data warehouse on execution, trade settlements, and corporate action events processing that is accessed through common browsers by asset managers, broker dealers, global custodians, and subcustodians.

### SUMMARY OF THE INVENTION

An object of the present invention is to provide a method and apparatus, using a secure virtual exchange and distributed relational database, which simplifies or manages the execution of cross border transactions.

Another object of the present invention is to provide a method and apparatus, using a secure virtual exchange and distributed relational database, which reduces overall costs and improves cross border trading.

Yet another object of the present invention is to provide a method and apparatus, using a secure virtual exchange and distributed relational database, that facilitates cross border financial transactions including payments, and particularly to facilitate cross border transactions that have been created by the expansion of global e-commerce.

A further object of the present invention is to provide a method and apparatus, using a secure virtual exchange and distributed relational database, that secures online market information and ‘audit-trails’ to broker dealers, banks and investment managers.

Still another object of the present invention is to provide a method and apparatus, using a secure virtual exchange and distributed relational database, that provides improved trading facilities and the associated risk management and control, decreasing potentially catastrophic operations risks and the number of failed trades.

Yet a further object of the present invention is to provide a method and apparatus, using a secure virtual exchange and distributed relational database, which provides access to critical information on investment patterns for the sale of associated products and services.

Another object of the present invention is to provide a method and apparatus, using a secure virtual exchange and distributed relational database, that provides integrated electronic trading facilities to institutional investors and broker dealers, including matching, confirmation and affirmation, clearing and settlement, and functionally and globally extends the reach of e-commerce for retail global investors.

Yet another object of the present invention is to provide a method and apparatus, using a secure virtual exchange and distributed relational database, which provides global custodians inexpensive and reliable online information and control of the clearing and settlement of their trades.

Still a further object of the present invention is to provide a method and apparatus, using a secure virtual exchange and distributed relational database, that provides global custodians with audit trails for successful as well as failed transactions.

Another object of the present invention is to provide a method and apparatus, using a secure virtual exchange and distributed relational database, which provides global custodians with flexible portfolio reporting on a customized basis, which is integrated across all the subcustodians.

Still another object of the present invention is to provide a method and apparatus, using a secure virtual exchange and distributed relational database, which provides global custodians with a distributed relational database for lending of securities.

Yet another object of the present invention is to provide a method and apparatus, using a secure virtual exchange and distributed relational database, that provides global custodians with integrated flexible reporting on taxes and corporate actions and a range of investment and risk management services based on integrated investment patterns.

Another object of the present invention is to build a modern system, capable of handling the current and future needs of cross border transactions by providing an Internet based method and apparatus, using a secure virtual exchange and distributed relational database.

Another object of the present invention is to build a modem system, capable of handling the current and future needs of cross border transactions by providing further value to the messaging capability of SWIFT by attaching a workflow that has knowledge of the context and content of the messages as they are sent and received, and their relationship to the workflow of a single cross border trade, providing participants in a given trade with the ability to track the progress of the logical transaction as the information flows between the participants in the trade.

Yet another object of the present invention is to build a modem system, capable of handling the current and future needs of cross border transactions by providing enhanced processing for corporate actions events (e.g. splits, tenders, rights issues, and dividends) through a secure virtual exchange that enables customized, integrated reporting of trading positions, announcements, instructions, recaps, and updates on portfolios.

### DETAILED DESCRIPTION OF THE DIAGRAMS

FIG. 1 is a schematic diagram illustrating the present relationship between global custodians, subcustodians, asset managers, and broker dealers. The box at the top of the diagram illustrates the so-called “execution” of the trade. The box at the bottom of the diagram illustrates the payment, foreign exchange, and the so-called settlement after the trade is executed. The arrows that cross the boxes indicate the movement of the execution file containing the details of the trade (e.g. 112 and 182) and the notification of settlement (e.g. 102 and 172). Note that each of the arrows depicted in the diagram represents one or more messages.

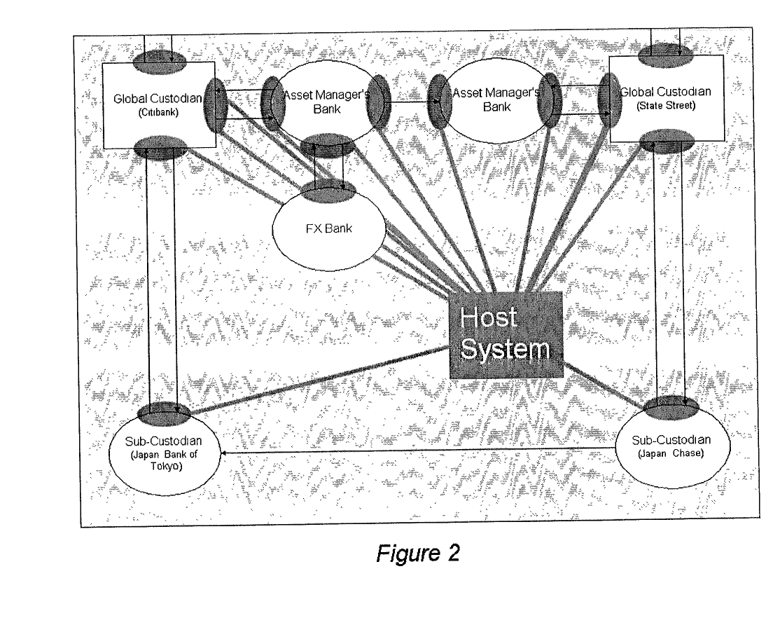

FIG. 2 is a schematic diagram of one embodiment of the present invention, applied to the settlement of trades, illustrating the method by which information is obtained from clients using the present invention.

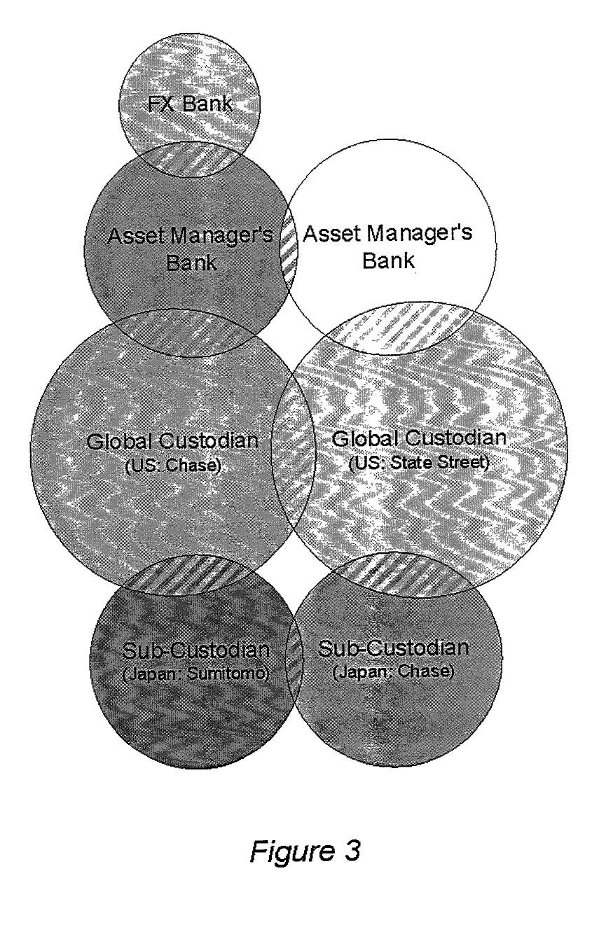

FIG. 3 is a schematic diagram of one embodiment of the present invention illustrating that data is organized in a decentralized fashion, representing all the clients using the present invention.

FIG. 3^{A} is a schematic diagram of one embodiment of the present invention that illustrates a distributed relational database, providing the functionality of a distributed virtual settlement system.

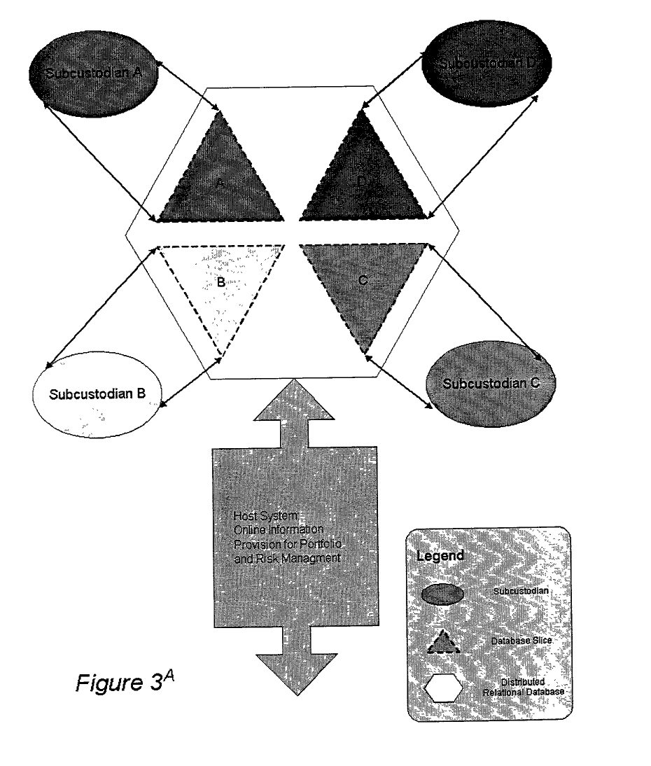

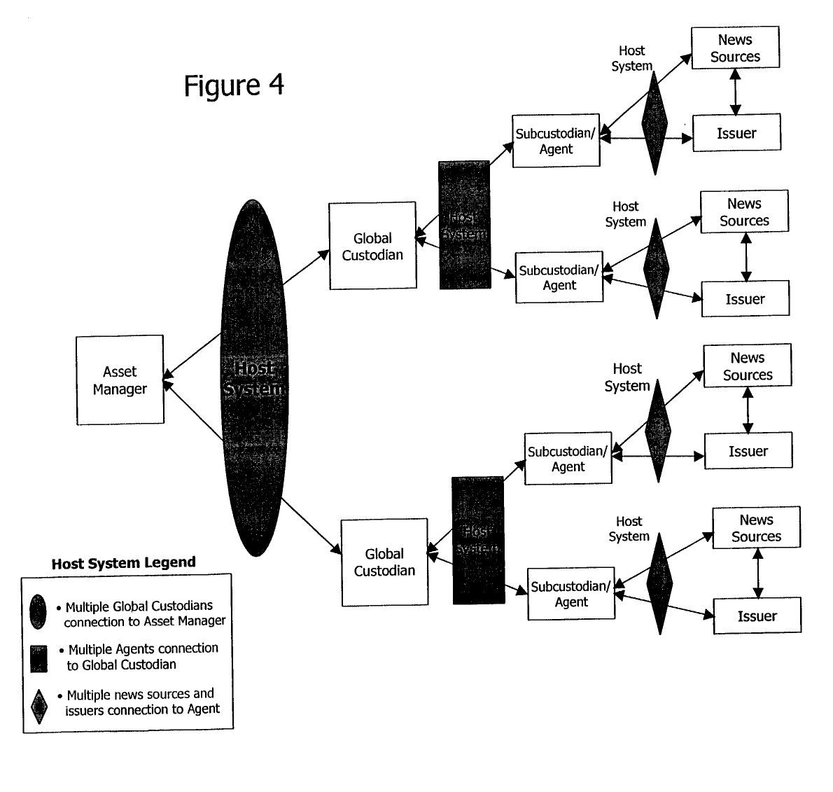

FIG. 4 is a schematic diagram of one embodiment of the present invention, illustrating its relationship with the global custodians. subcustodians and asset manager clients.

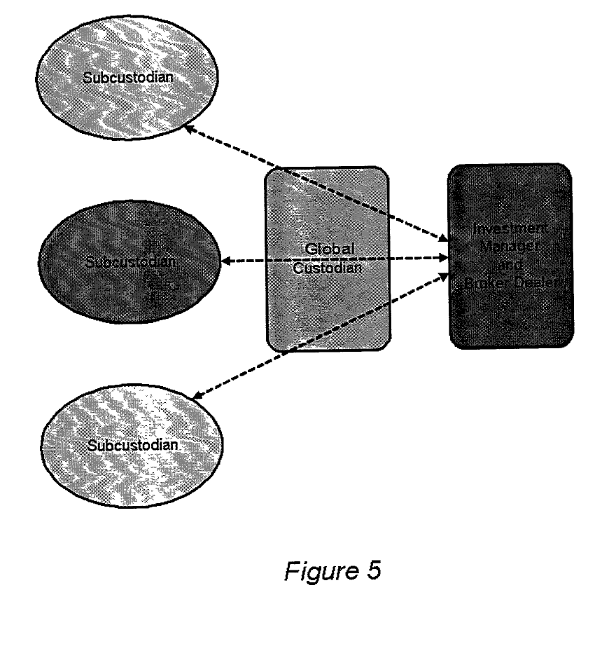

FIG. 5 is a schematic diagram illustrating the role of the global custodian in the middle of the information stream between the subcustodian and the client. In an embodiment of the present invention, this role is assumed by the current invention itself.

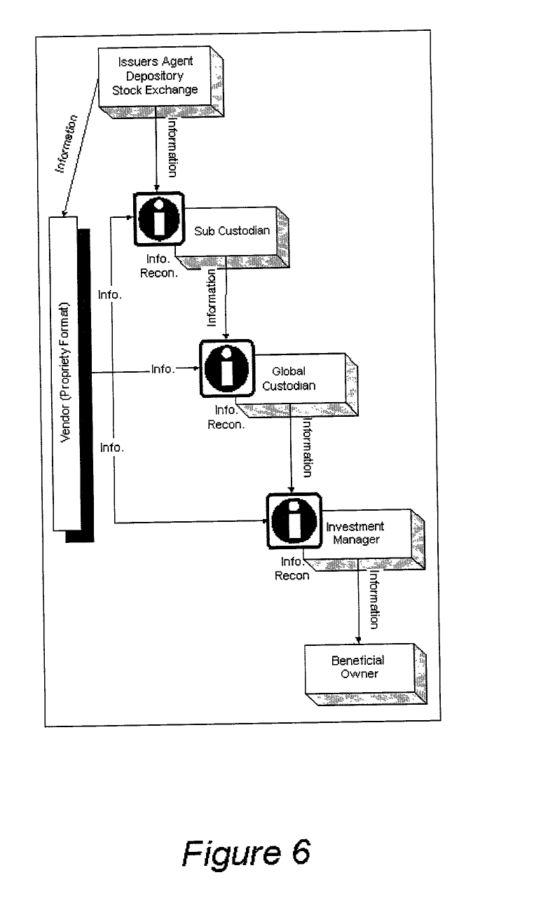

FIG. 6 is a schematic diagram illustrating the current corporate action information process, one not embodied by the present invention.

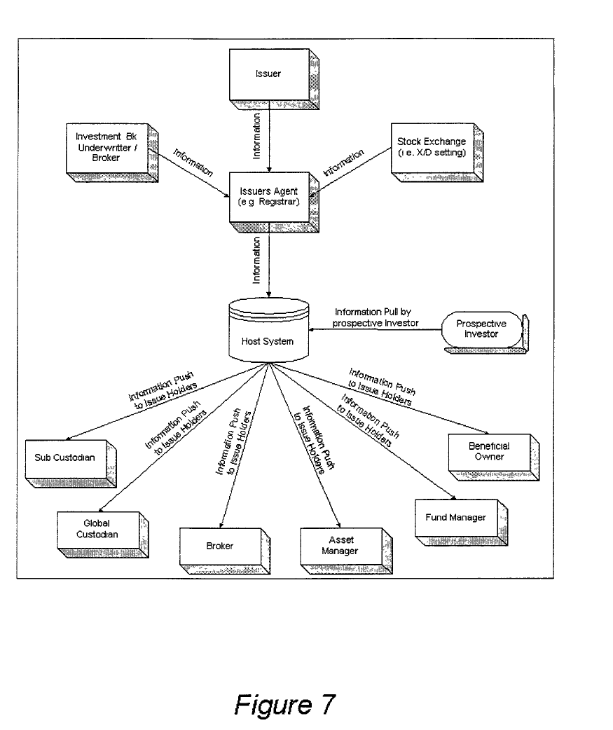

FIG. 7 is a schematic diagram of one embodiment of the present invention, illustrating the improvements to the corporate action information process provided by the present invention.

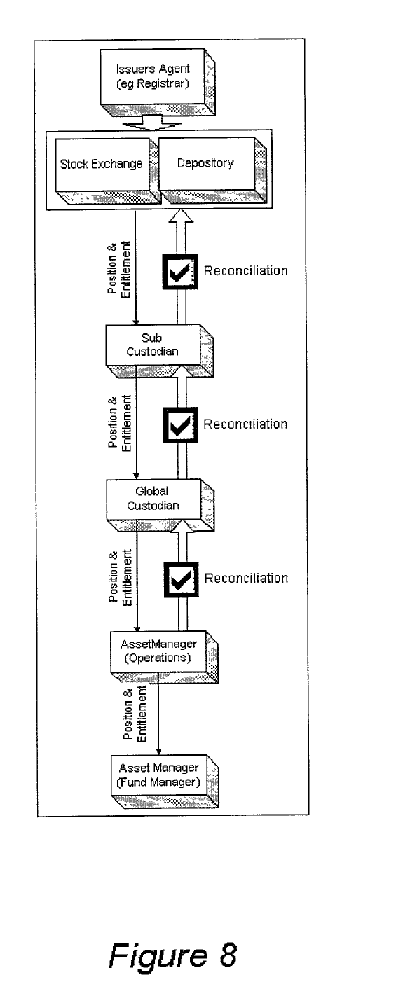

FIG. 8 is a schematic diagram illustrating the current corporate action reconciliation process, one that is not embodied by the present invention.

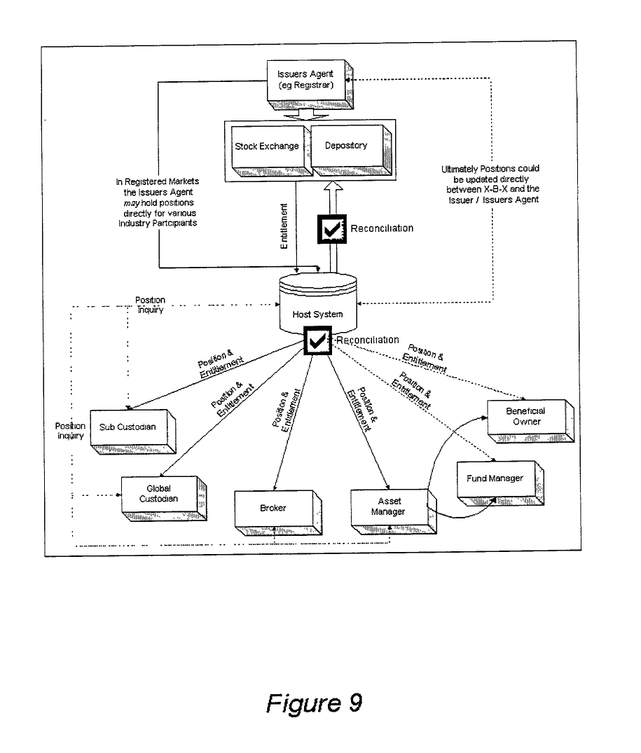

FIG. 9 is a schematic diagram of one embodiment of the present invention, illustrating the improvements the present invention makes upon the current corporate action reconciliation process detailed in FIG. 7.

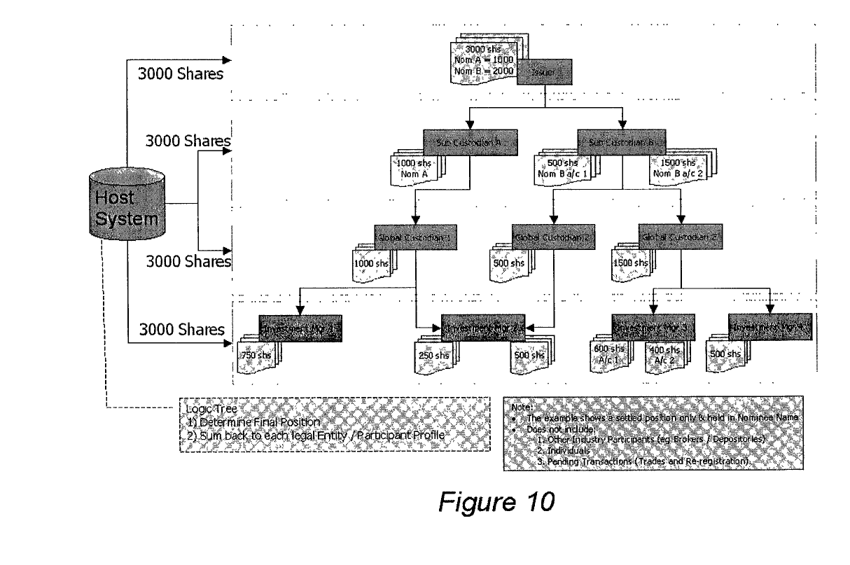

FIG. 10 is a schematic diagram of one embodiment of the present invention, illustrating a specific example of the corporate action reconciliation process diagramed in FIG. 8.

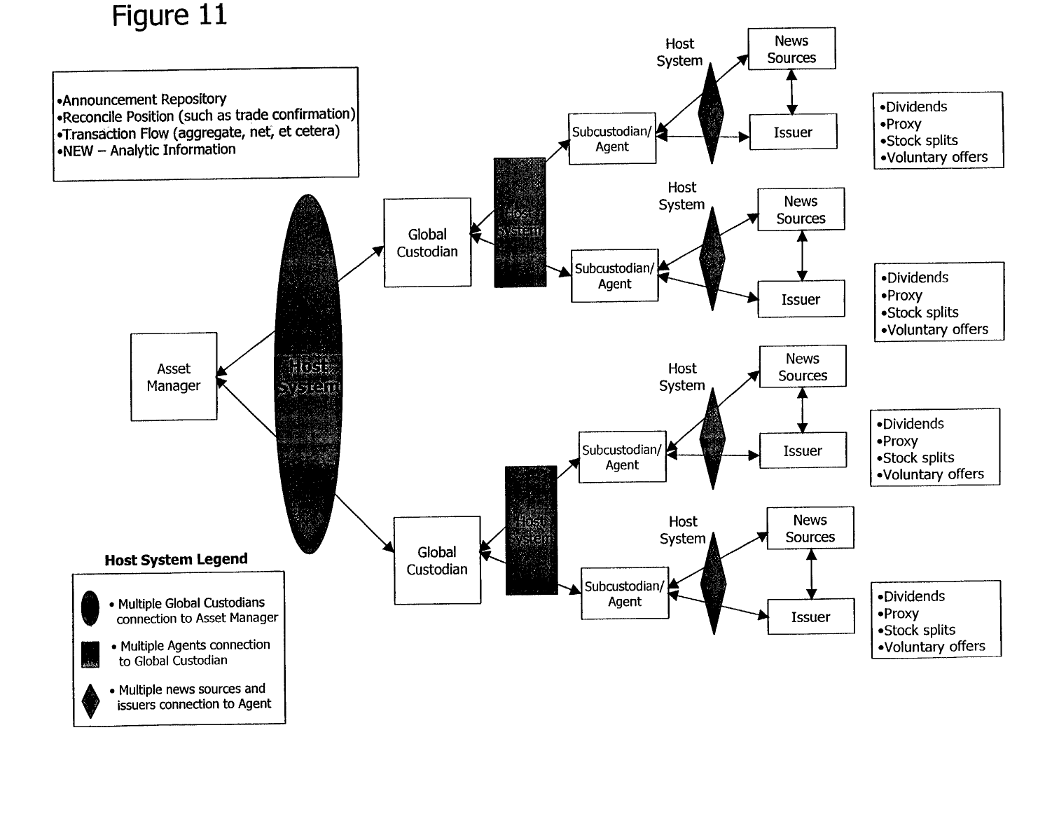

FIG. 11 is a schematic diagram illustrating the role of an embodiment of the present invention in improving the information flows as they are involved in the processing of corporate actions globally. The first component of the Host System (depicted as the solid diamonds) provide for intelligent capture of dividends, proxies, stock splits, voluntary offers, and other corporate actions event information flowing from the news sources and issuers to the subcustodian. The first component of the Host System provides automated workflow for the processing of the event information that alerts individuals in the appropriate institution to errors and conflicting source data. The second component of the Host System (depicted by the solid rectangles) provides automated workflow and reconciliation for the processing of omnibus level entitlement and event information provided by subcustodians to a global custodian. The third component of the Host system (depicted by the solid oval) provides automated workflow and reconciliation for the processing of account level entitlement and event information provided by global custodians to an asset manager. The third component also provides real time analytic information to the global custodian relating to voluntary elections made by asset managers.

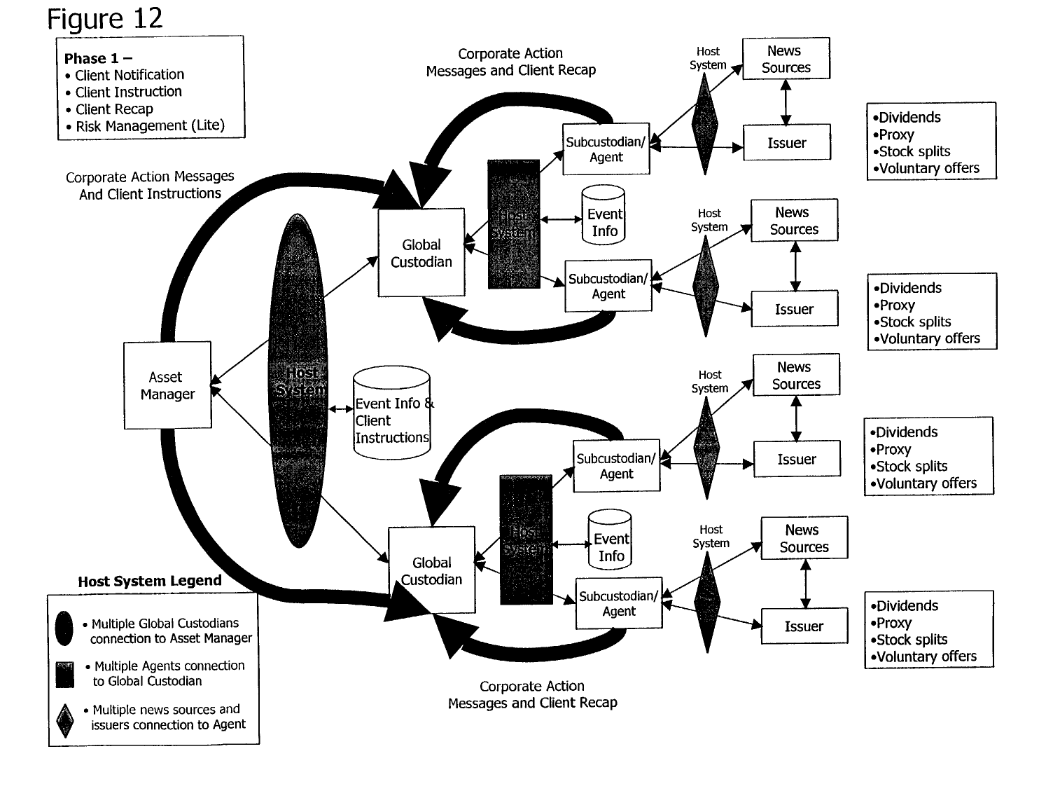

FIG. 12 is a schematic diagram illustrating an embodiment of the present invention, providing a first phase in implementing the present invention for corporate actions processing. Specifically, the first component of the Host System (depicted by solid diamonds) provides corporate action event information from the news sources and issuers to the subcustodian; the second component of the Host System (depicted by solid rectangles) provides corporate actions event information to the global custodian from the subcustodians. The third component of the Host System provides corporate actions event information from the global custodians to the asset manager. Additionally, the three combined components provide risk management capabilities for each institution by using automated workflow and notification facilities.

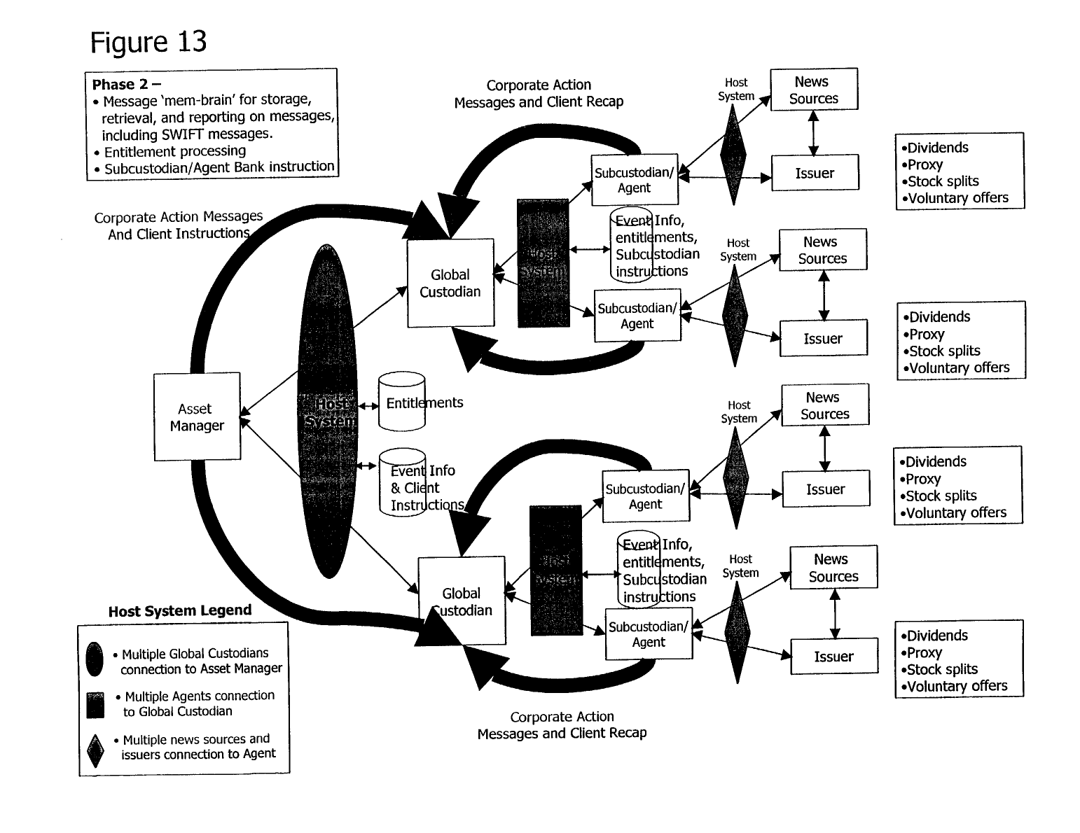

FIG. 13 is a schematic diagram illustrating an embodiment of the present invention, providing a second phase in implementing a secure corporate actions exchange. Specifically, during the second phase all three components of the Host System provide a message “mem-brain” (memory and brain) facility for the intelligent capture, storage, retrieval, and reporting of corporate actions messages, including SWIFT messages. Furthermore, the second component (depicted by the solid rectangles) provides automatic entitlement processing for the omnibus accounts of global custodians by a subcustodian and the capture of subcustodian instructions to a global custodian. Additionally, the third component of the Host System (depicted by the solid ovals) provides automatic entitlement processing for the asset manager accounts controlled by a global custodian.

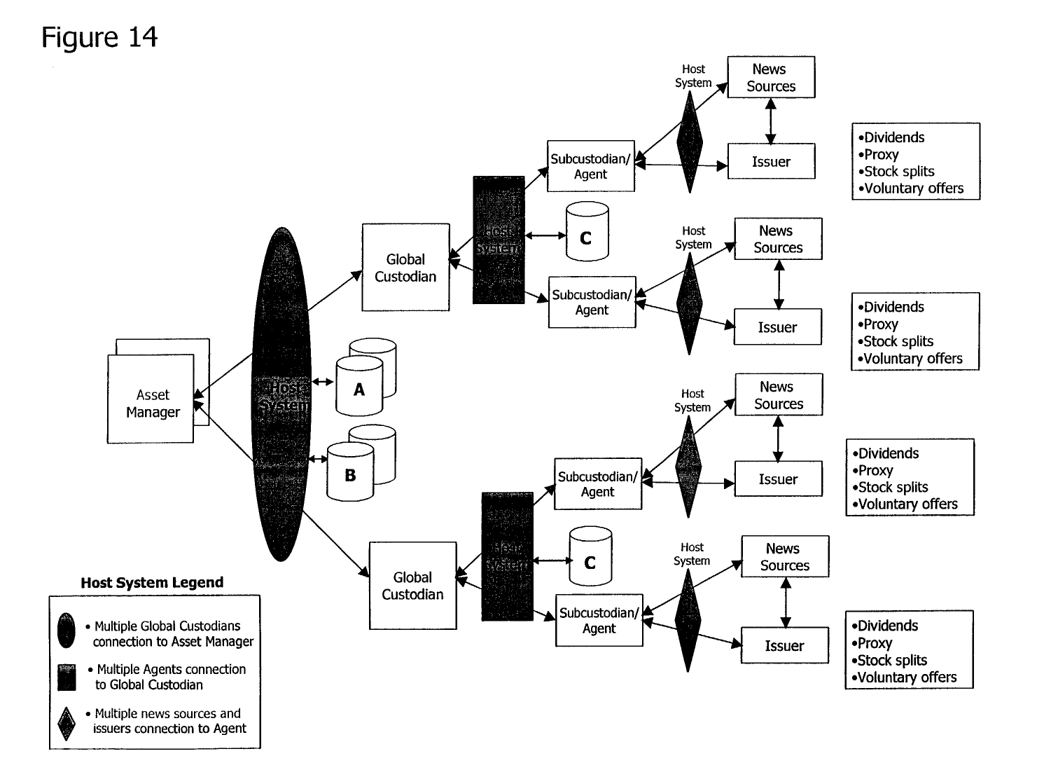

FIG. 14 is a schematic diagram illustrating the role of an embodiment of the present invention in providing a direct connection between issuers (i.e. originating firms) and asset managers in a final phase (“end-to-end” solution). Specifically, multiple asset managers connect via the third component (depicted by the solid oval) to a secure “slice” of the entitlement database (depicted by the database labeled ‘A’). Each slice of the database provides an asset manager a secure and private a view into the Host System to their data only. The third component of the Host System also stores Event information and Client Instructions in secure “slices” of the database labeled “B”. The second component of the Host System (depicted by the solid rectangles) provides a secure sliced database of entitlement information, client instructions, and event information to each global custodian, which is depicted by the database labeled “C”.

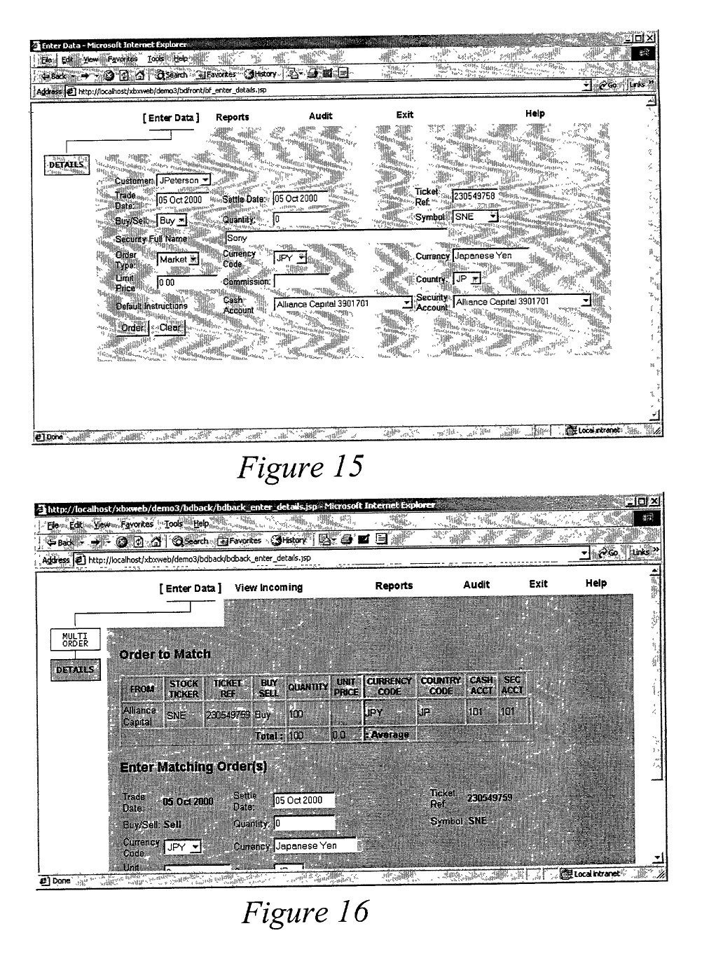

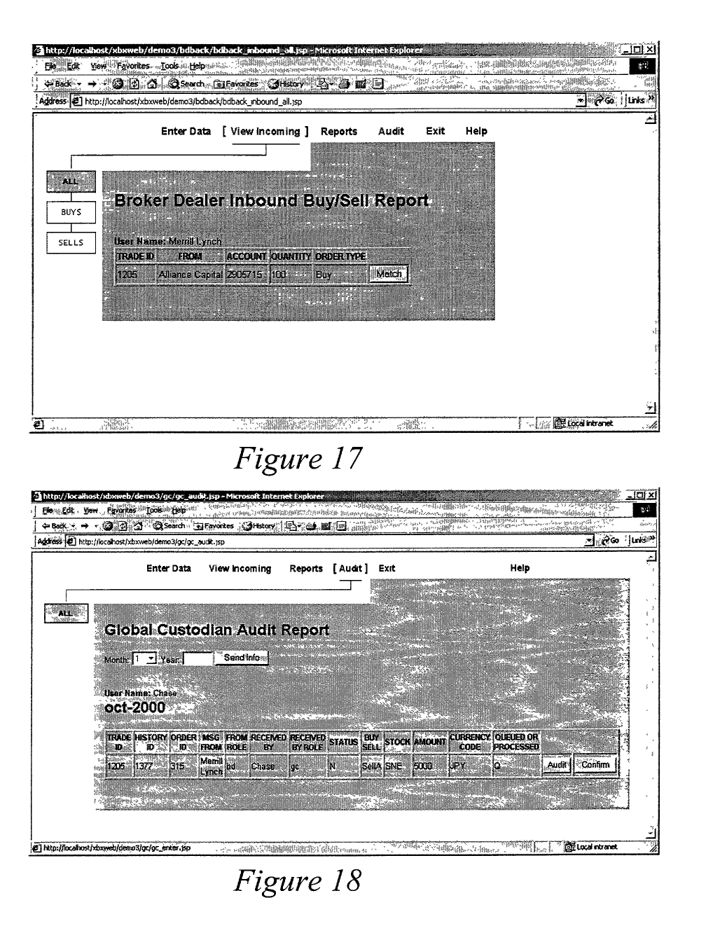

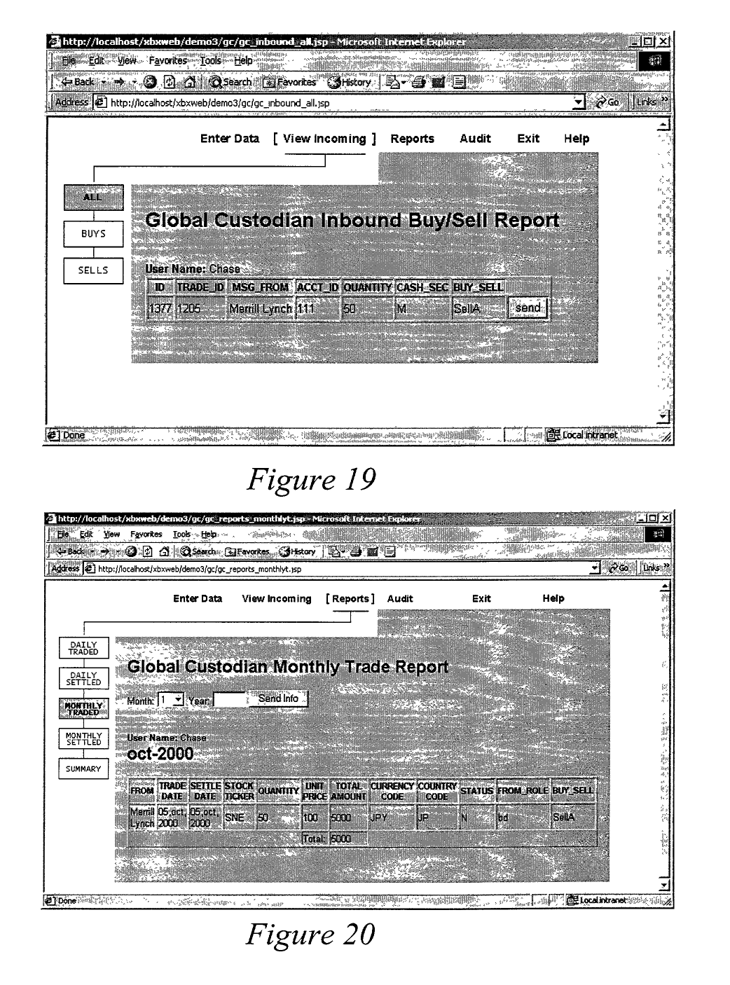

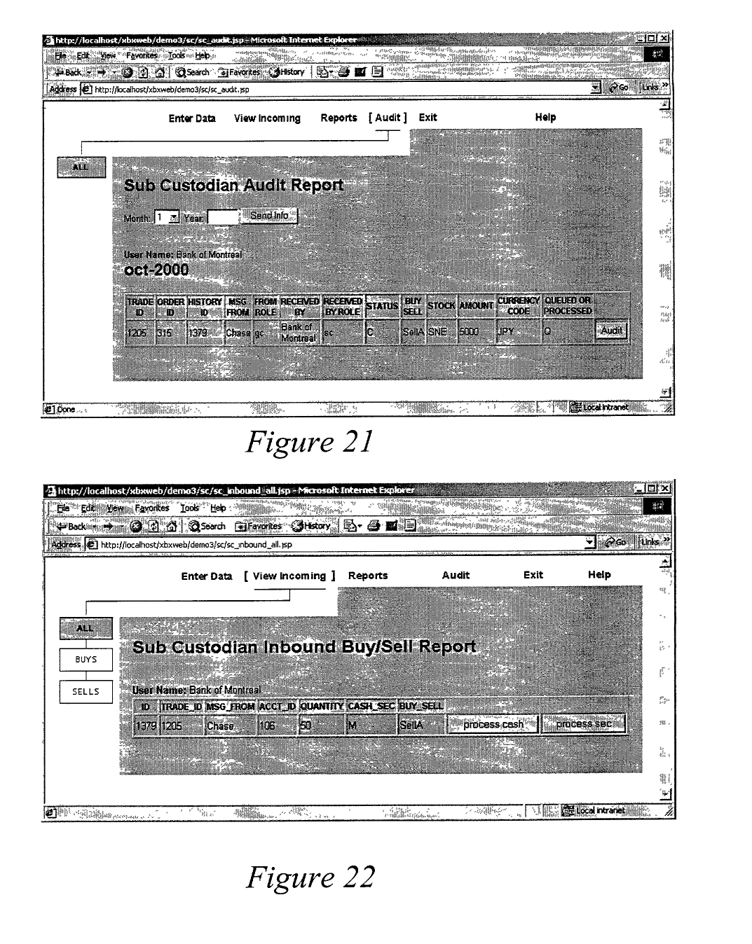

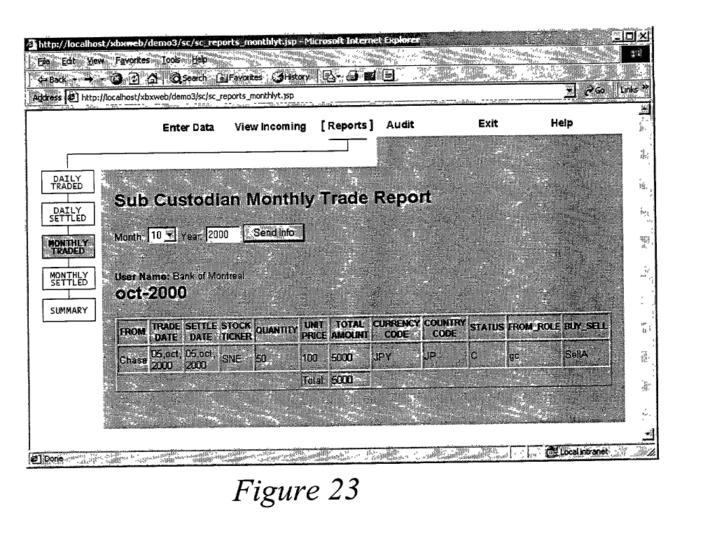

FIGS. 15 through 23 are screen shots, showing examples of the screens a client using an embodiment of the present invention may see.

### DETAILED DESCRIPTION OF THE PREFERRED EMBODIMENTS

One embodiment of the present invention is: a generic network of subcustodians organized around an Internet based secure virtual exchange with a distributed relational database. With the secure virtual exchange of the present invention, subcustodian banks hold the actual securities in their respective countries. Even though the subcustodian banks hold the securities, the present invention provides the informational equivalent of the securities at the global level of the DTCC.

FIG. 2 is a schematic diagram of one embodiment of the present invention, applied to the settlement of trades, illustrating the method by which information is obtained from clients using the present invention. As data arrives into, or is sent from, one of the clients of the present invention, the data is copied to the distributed database. This is shown in the diagram as transparent ovals, connecting to a box representing this embodiment of the present invention.

FIG. 3 is a schematic diagram of one embodiment of the present invention illustrating that data is organized in a decentralized fashion, representing all the clients using the present invention. It further shows that all the data pertaining to one logical transaction is stored in the database, providing all the participants in a given trade/settlement with the ability to track the progress of the transaction. Access to specific, security sensitive details of the transaction is limited to those portions of the transaction with which the client has had direct dealings. When two clients are involved in one part of the total transaction, the detailed data is available to both where the diagrams show overlap, represented by striped lines.

FIG. 3^{A} is a schematic diagram of one embodiment of the present invention that illustrates a distributed relational database, providing the functionality of a distributed virtual settlement system. The present invention separates informational flows from paper and other physical flows. It provides the informational services of a (virtual) generic subcustodian and a (virtual) generic global custodian, offering the investor and broker/dealer integrated access to the subcustodians. In FIG. 3^{A}, the subcustodians are the ultimate holders of assets and information worldwide. The distributed relational database of the present invention contains ‘slices’ which are specific to each subcustodian, separated by firewalls for strict confidentiality. In the illustration, the database is represented by a hexagon containing several colored triangles. Each triangle represents a database ‘slice’, and is the informational equivalent of the subcustodian of the same color. The physical securities themselves remain at their location today, in the respective subcustodians and countries, but the flow and the stock of information have been reorganized and streamlined, and are provided online.

FIG. 4 is a schematic diagram of one embodiment of the present invention, illustrating its three different components with three different institutions: subcustodians, global custodians, and asset manager clients. In FIG. 4, the first component (represented by a solid diamond) relates a subcustodian to multiple news sources and issuers. The second component (represented by a solid rectangle) related a global custodian to multiple subcustodians. Finally, the third component (represented by a solid oval) relates an asset manager to multiple global custodians. Each component creates its own virtual private network of institutions. Specifically, the first component creates a virtual private network of subcustodians and their news sources and issuers. The second component creates a virtual private network of global custodians and their subcustodians. The third component creates a virtual private network of asset managers and their global custodians.

The secure virtual exchange of the present invention can be built using Internet technology with a distributed relational database and audit trails for simultaneous updating of the data associated with the transactions. In various embodiments, the secure virtual exchange and distributed relational database of the present invention can have:

User-friendly Internet interfaces, including graphics and voice-driven data entry. FIGS. 15 through 23 contain images of example interface screens.

A powerful distributed relational database that scales with increased load, allowing for the gradual upgrading from hundreds to thousands and eventually millions of clients, quickly and effortlessly.

Firewalls and Internet encryption mechanisms that protect the clients' sensitive trading data.

Streamlined and standard formats adapted to existing and developing clearing and settlements processes for global transactions in various markets.

A ‘utility-like’ port for easy and attractive installation and upgrading, which can be supported by a wide range of hardware.

A simple, universal interface to the in-house accounting, trading and payment systems currently in use in the financial industry so as to provide effortless and transparent inputs.

A simple, universal ‘electric switch’ connection to all major market systems serving the financial industry, including:

real or virtual stock exchanges such as NASDAQ, NYSE, SIMEX, BSX, and E*Trade

clearing and settlement institutions such as DTCC, JASDEC, SICOVAM

payment and transfer systems such as SWIFT, CEDEL, Euroclear, and FIX

A ‘modular’, highly integrative and connective strategy.

The ability to facilitate cross border financial transactions including payments, and particularly those transactions created by the expansion of global e-commerce.

In various embodiments, the present invention provides integrated electronic trading facilities to institutional investors and broker dealers, including matching, confirmation and affirmation, clearing and settlement. Additionally, the present invention extends functionally and globally the reach of e-commerce to capture the retail global investor of the future. Further, the present invention, taking advantage of the capabilities of the Internet, improves information transmission, storage, and analysis by separating information flow from material flow. By improving the efficiency of the information flow without changing the material flow, one still improves the overall process, by providing improved knowledge about the status of the process. The improved availability of information, in turn, enables additional value analysis that can impact favorably other related processes.

In another embodiment, the present invention avoids the use of proprietary systems and hardware that inhibit connectivity, and offers an Internet based solution that maximizes connectivity and the use of open Internet technologies. This embodiment of the present invention provides the following online information services for the following:

Matching, confirmation, affirmation, reconciliation, execution, foreign exchange, payments, and settlements.

Data on trade processing, including executions and settlements.

Automated trouble-shooting for fails when appropriate.

Information flows on corporate actions (dividends, splits, tenders, and rights issues) and taxation.

Integrated and flexible portfolio reporting.

Borrowing and lending facilities.

Risk evaluation and management to support the ever-shortening settlement cycle worldwide.

Additionally, this embodiment of the present invention is a global Internet based method and apparatus for securities that:

Reduces overall costs and improves cross border trading of securities.

Uses a secure virtual exchange and distributed relational database to simplify the execution of cross border transactions.

Secures on-line market information and ‘audit-trails’ to broker dealers, banks and asset managers.

Provides improved trading facilities and the associated risk management and control, and decreases potentially catastrophic operations risks and the number of failed trades.

Provides access to critical information on investment patterns for the sale of associated products and services.

Provides integrated electronic trading facilities to institutional investors and broker dealers, including matching, confirmation and affirmation, clearing and settlement, that extends functionally and globally the reach of e-commerce for retail global investors.

Provides global custodians with inexpensive and reliable online information and control of the reconciliation, clearing and settlement of their trades.

Provides global custodians with audit trails for failed transactions.

Provides global custodians with flexible portfolio reporting on a customized basis that is integrated across all the subcustodians.

Provides global custodians with a distributed relational database for corporate actions, lending of securities, and other services associated to cross border trade processing and custodization.

Provides global custodians with integrated flexible reporting on taxes and corporate actions and a range of investment and risk management services based on integrated investment patterns.

The secure virtual exchange of the present invention, which includes custodians and subcustodians worldwide, enables asset managers and their foreign custodial brokers to conduct business efficiently, online seven days a week and 24 hours a day. In various embodiments, the secure virtual exchange of the present invention can be transparent, with private labels for the services to the global custodians, or non-transparent.

### Trade Settlements and Corporate Actions

In various embodiments, the present invention provides asset managers and its broker dealer with direct online access to information on clearing and settlement, as well as portfolio information held by the subcustodian. Additionally, the secure virtual exchange enables customized, integrated reporting of trading positions, announcements, instructions, recaps, and updates on portfolios for corporate actions events (splits, tenders, rights issues, and dividends) and taxes, facilitating the borrowing and lending of securities. FIGS. 11 through 14 illustrate on embodiment of the present invention as applied to corporate actions.

### Improvement on Swift Messaging

In one embodiment, the present invention adds further value to the message capability of SWIFT by attaching a workflow that has knowledge of the context and content of the messages captured as they are sent and received, and their relationship to a single cross border trade. By capturing all the messages related to a given settlement and associating them with a single, logical transaction, tremendous value is added to the process. It provides participants in a given trade with the ability to track the progress of the logical transaction related to a given settlement as the information flows between the participants.

Furthermore, it can preemptively generate messages to the various participants in a transaction if responses to messages/actions do not take place within a given amount of time (the specifics for each participant are stored in a centralized profile database).

The following is an outline of one embodiment of such a process (referring to FIG. 1)—built upon the apparatus and technology of the present invention—as applied to post trade settlement, assuming a single global custodian in the trade (in this case, the one on the left) is a client for the apparatus is:

Obtain a copy of the execution file sent from the broker dealer to the global custodian (e.g. step 112, FIG. 1)

If the execution file is sent via SWIFT, the embodiment of this invention can obtain it from the SWIFT gateway.

If it is in another electronic format, the global custodian sends a copy electronically.

If it comes in via FAX, the global custodian sends a message containing an electronic copy once it is keyed into their system.

Assign a unique logical transaction number to the settlement detailed in the execution file.

Examine the profile database of the global custodian for the “standing instructions” the global custodian has from asset managers originating the trade, pertaining to the trade detailed in the execution file (e.g. payments and foreign exchange banks, etc.).

If the standing instructions are not found:

Obtain a copy of the standing instructions from the global custodian

Else,

Verify the instructions are current

If not, get the latest copy of the standing instructions

Monitor the traffic at the global custodian (e.g. messages 102, 103, 112, 113, 121, and 122 in FIG. 1) and match those messages to the logical transaction, based upon their content, their implicit relationship to the settlement detailed in the execution file, and upon the global custodian's standing instructions.

Update the settlement in the workflow database, indicating the state of the settlement.

Fire any conditional workflow related triggers related to time/content, based upon the global custodian's profile database entry. This step could involve proactively sending messages to the global custodian to let them know certain conditions have been met (for example message 113 (FIG. 1) was sent and message 103 (FIG. 1) was not received within a specified number of days).

Allow the global custodian to interrogate the workflow database as appropriate, to determine the current state of the settlement transaction.

The transmission/receipt of other messages is assumed, based upon other messages received. For example, the receipt of 113 (FIG. 1) implies inter alia 153 and 154 (FIG. 1), as well as 131, 141, 152, 161, 162, and 183 (FIG. 1).

When additional participants in the settlement elect to become clients of the apparatus described by the present invention, their traffic is associated with the transactions as well. This provides the distributed relational database with explicit information regarding the settlement, replacing the implicit information previously available. For example, when the other global custodian in FIG. 1 (in this case, the one on the right) becomes a client, their messages are tracked as well (e.g. 161, 162, 172, 173, 182, and 183 in FIG. 1). Because the execution file sent in 182 (FIG. 1) has the same data as that sent in 112 (FIG. 1), the messages are associated with the same workflow. An additional benefit is that any discrepancies in the execution file can be detected an resolved, earlier resulting more reliable settlement for the custodians and therefore a lower cost since the potential for failure would be detected early in the process.

When the subcustodians become clients, previously implicit information becomes explicit, as the subcustodian provides us with direct knowledge of 154 (FIG. 1).

Finally, when the Asset Manager Banks become clients, the information about 153, 131, and 141 (FIG. 1), that was previously implicit becomes explicit.

In addition to explicit information, the addition of the other participants in the settlement allows them to obtain information about the progress of the transaction as well. Furthermore, the apparatus described by the present invention will be able to proactively send information to the clients if it detects a problem. For example:

If both the global custodian and the subcustodian on the left are clients, and message 113 (FIG. 1) is sent from the global custodian to the subcustodian, and the subcustodian does not send message 103 (FIG. 1) to the global custodian in the time indicated, notification is sent to the subcustodian that the global custodian needs a response to its message (113, FIG. 1).

Since the subcustodian is a client as well, XBX can inform the subcustodian in the message that 103 (FIG. 1) was not sent either because 154 (FIG. 1) was not received, or because of some other problem not related to the reception of 154 (FIG. 1).

If the subcustodian still doesn't respond with 103 (FIG. 1) to the global custodian, notification is sent to the global custodian. Since the subcustodian is a client, information about that status of 154 (FIG. 1) is included in its message to the global custodian.

The system described above applies to any transaction system where multiple custodians are involved, including, but not limited to reconciliation, billing, and corporate actions—the settlement process was detailed only as an example.

The embodiment of the present invention described above will fulfill many of the objectives described in the summary section above.

Referring now to FIG. 5, one embodiment of the secure virtual exchange of the present invention is illustrated and offered on a private label basis on behalf of a global custodian. In FIG. 5, the global custodian is in the middle of the information stream between the subcustodian and the client.

The distributed relational database of the present invention provides the subcustodians with an ability to upgrade their services at minimal costs that are transaction dependent. By the appropriate use of Internet-based technology the present invention provides the subcustodians with:

On line, effective and reliable communications with global custodians and investors.

An internal database for handling the subcustodian's assets and audit-trails. In one embodiment of the present invention, fees are charged on a transaction-based (or variable) schedule and permits subcustodians to update their technology.

With the present invention, records and audit trails are provided for assets in an Internet-based distributed relational database and services become the global equivalent of the DTCC. However, the database of the present invention is different from the DTCC or other national or global clearing facility because data is organized in a decentralized fashion and can be resident in linked subcustodian's databases as shown in FIG. 3. The role of the subcustodian remains as is today, but is greatly strengthened.

In FIG. 3, the present invention provides the informational services of a generic subcustodian and a generic global custodian. This offers the investor and broker dealer integrated access to the subcustodian, which are the ultimate holders of assets and information. The generic distributed relational database of the present invention contains segments that are specific to each subcustodian that are separated by segments for strict confidentiality. In FIG. 3, the database of the present invention is represented by a set of overlapping circles. Each circle represents a database segment, and contains information relating to the custodian/bank in the trade. The securities themselves remain at their location today, in the respective subcustodians and countries, but the flow and the stock of information have been reorganized and streamlined, and are provided online.

The current process for corporate action information process detailed in FIG. 6 is one that:

Detaches the Issuer from the Investor.

Has multiple layers with repetitive and redundant processes.

Is manual and inefficient, which creates risk and cost.

Is paper driven, which causes breaks in straight through processing.

The embodiment of the current invention, applied to the corporate action information process, diagramed in FIG. 7 is one that:

Greatly reduce costs and risks.

Provides added value to the Issuer and Investor by bringing the Issuer and Investor closer.

Provides a single source of real time updated information with multiple uses to all the industry participants.

Brings new technologies to simplify and improve a complex and risky process.

Provides aggregate statistical anonymous data on investment flows, as well as opportunities for ‘triage’ or ‘arbitrage’.

Provides an impetus to a new industry paradigm.

Making the assumptions that the Issuer Information is generally available to the Industry and that the Individual Investor's Instructions are the sole property of the Issuer and Investor, the embodiment of the current invention diagramed in FIG. 7, provided the following benefits over the existing process, diagrammed in FIG. 6:

To the Issuer:

Instant Delivery of Information (Flexible, Graphical & Company Details) directly to the Investors

Single Data source for prospective Investors

Effective Legal Information process:

Sophisticated Investor Letter

Direct delivery between Issuer and Investor

Monitoring of outstanding Letters

Ownership Disclosure

e.g. Section 212 of the UK Companies Act 1985

To the Investor:

Information Push delivered over the Internet directly to Investor determined recipients (Investor Profile)

Streamlined Instruction process will enable Instructions closer to Issuer Deadlines

Historical Information retained on easily accessible/flexible format Database

Effective Legal Information process e.g. Sophisticated Investor Letter:

Direct delivery between Issuer and Investor

Monitoring of outstanding Letters

To the Industry:

Single Source of Data which puts the Responsibility and Risk on the Issuer to provide correct Information

Encourage Issuer Standards of Information

Efficient Entitlement claim process by Transaction tracking and Settlement

Streamlining an inefficient paper driven process which will sharply reduce Costs and Risk

The current process for corporate action reconciliation (and is also used for Entitlement Reconciliation) detailed in FIG. 8 is one that:

Multi Layered with repetitive processes and single stock records

Single Entity to Single Entity reconciliation Process at multiple points

Daily Batch Process

Position Exceptions reported at Aggregate Level

The embodiment of the current invention, applied to the corporate action reconciliation process, diagramed in FIG. 9 is one that provides:

A single source of data (i.e. Global Stock Record)

Reconciliation with exception reporting at Single or Multiple participants level

Exception Reporting by Unique Transaction number

Exception Reporting with ‘probable’ root cause

Real Time Reconciliation

Internet Delivered Reporting

The embodiment of the current invention diagramed in FIG. 9, provides the following benefits to the Issuer, Investor and Industry over the existing corporate action reconciliation process, diagrammed in FIG. 8:

A reduction in number of Entities performing Reconciliation Processes

A reduction in number of messages sent and cost

Provide End-to-End Reconciliation

Provides the ‘linkage logic’ that is required to bring the Issuer and Investor closer

A reduction in Time from Transaction to Reconciliation

Provide increased reconciliation points and methods

A reduction in costs and risks

In various embodiments, the secure virtual exchange of the present invention is a generic transaction platform for a wide and profitable range of services to several thousands asset managers and broker dealers which are naturally connected with the trade and post-trade processes. These include but are not limited to matching, confirmation and affirmation, audit trails, clearing and settlements, borrowing and lending of securities and updates on corporate actions.

In one embodiment, the present invention offers global custodians the ability to outsource some of their global custody services, such as the communications to their networks of subcustodians, merging these services into a virtual global custody network. In another embodiment, the present invention provides an ability to monitor performance and act expediently in foreign markers.

The foregoing description of a preferred embodiment of the invention has been presented for purposes of illustration and description. It is not intended to be exhaustive or to limit the invention to the precise forms disclosed. Obviously, many modifications and variations will be apparent to practitioners skilled in this art.

What is claimed is:

1. A method for automating trade settlements, comprising:
providing a host system or systems with a distributed relational database accessible and updateable by more than one party to a cross border transaction:
caching a client's standing settlement instructions in a client profile in the distributed relational database;
monitoring messages of a selected trade settlement client; and
assigning a unique transaction identifier of a trade settlement for messages that include an execution file or a settlement of a trade.

2. The method of claim 1, further comprising:
receiving at the host system (or systems) an execution file that includes trade settlement parameters; and
matching messages of the selected trade settlement process using the information in the execution file and the standing instruction parameters and adding said messages to the logical transaction workflow

3. The method of claim 2, further comprising:
marking matched messages with the transaction identifier; and
storing the marked traffic in the distributed relational database as part of a logical transaction for a trade settlement.

4. The method of claim 1, wherein the monitoring is done by an electronic file transfer.

5. The method of claim 4, wherein the electronic file transfer is from a client's computer network to the host network system.

6. The method of claim 4, wherein the monitoring is done with a standard web browser.

7. The method of claim 1, wherein the client standing instructions include instructions for executing a trade including, but not limited to clearing methods, name of correspondent banks, sub agent or sub custodian, name of sub agent, client tax identification number, and account type.

8. The method of claim 1, wherein the execution file includes information about a specific trade, including, but not limited to, payment currency, client name, trade date, settlement date, security name, security type, and security code.

9. A method for automating trade settlements, comprising:
providing a host system with a distributed relational database accessible and updateable by more than one party to a cross border transaction;
receiving a copy of an execution file from a broker dealer to a global custodian;
assigning a unique logical transaction number to a settlement detailed in the execution file;
examining a profile database of the global custodian for the standing instructions from asset managers originating the trade;
monitoring traffic at the global custodian;
matching messages to the logical transaction process based upon content, their implicit relationship to the settlement detailed in the execution file, and the global custodian's standing instructions;
updating the settlement in the workflow database, indicating the state of the settlement;
firing any conditional workflow related triggers related to time/content, based upon the global custodian's profile database entry;
allowing the global custodian to interrogate the workflow database to determine the current state of the settlement transaction.

10. A method for automating corporate action information process, comprising:
providing a host system with a distributed relational database accessible and updateable by more than one party to a cross border transaction;
receiving information from an issuers agent and prospective investors at the host system; and
distributing the received information to issue holders.

11. A method for automating a corporate action process, comprising:
providing a host system with a distributed relational database accessible and updateable by more than one party to a cross border transaction;
receiving an issue holder's position and entitlement information from an issuer's agent and at least one stock exchange or a stock depository at the host system; and
simultaneously sending the issue holder's position and entitlement information to all participants in a reconciliation process.

12. The method of claim 11, further comprising:
sending reconciliation information relating to the issue holder's position and entitlement to the stock depository.

13. The method of claim 10, wherein the corporate action process is selected from reconciliation, billing, tender offers, splits, dividends, rights issues, cash or stock dividends and proxy.

14. A system for automating cross border transactions, comprising:
a host system with a distributed relational database accessible and updateable by more than one party to a cross border transaction;
at least one global custodian network coupled to the host system; and
at least one sub-custodian coupled to the host system and the global custodian network.

15. The system of claim 14, further comprising:
at least one FX band coupled to the global custodian network.

16. The system of claim 15, further comprising: at least one asset manager bank network coupled to the FX bank network and the global custodian network.

17. The system of claim 14, wherein all data pertaining to one logical transaction is stored in the distributed relational database.

18. The system of claim 14, wherein all participants in a trade or settlement can track the progress of the trade or settlement with access to the distributed relational database.

19. The system of claim 14, wherein the distributed relational database includes firewalls that separate information specific to subcustodians.

20. The system of claim 14, wherein the distributed relational database includes details on the execution, audits, trade settlement, and standing instructions for trade processing.

21. The system of claim 14, wherein each participant retains specific information that pertains to knowledge it has at a selected time.

22. The system of claim 14, wherein subcustodians retain information about all global custodians' omnibus accounts that they serve.

23. The system of claim 14, wherein global custodians retain information about all the asset managers' accounts and broker dealers' accounts that they serve.

24. The system of claim 14, wherein broker dealers retain information about all the investors' accounts that they serve.

25. A method of improving bank to bank instructions between financial institutions, comprising:
providing a host system with a distributed relational database accessible and updateable by more than one financial institution; and
transmitting messages between financial institutions for payments, foreign exchange, executions, settlements, or corporate actions providing knowledge of the content and context of the messages as they are sent and received, and identifying their relationship to a single trade or corporate actions event.

26. A method for centralizing information required to settle a global cross border transaction, comprising:
providing a host system with a distributed relational database accessible and updateable by more than one party to a cross border transaction;
creating audit trails for cross border transactions utilizing the host system.

27. The method of claim 26, wherein the host system provides a secure virtual exchange that enables customized, integrated reporting of trading positions, announcements, instructions, matches, recaps, updates, reconciliation, and billing among other services.
